(19) United States
(12) Patent Application Publication
(10) Pub. No.: US 2014/0013135 A1
(43) Pub. Date: Jan. 9, 2014

(54) SYSTEM AND METHOD OF CONTROLLING A POWER SUPPLY

(71) Applicants: Emilio López MATOS, Sant Cugat del Valles (ES); Roger Bastardas Puigoriol, Sant Just Desvern (ES); Santiago Garcia Garcia, Barcelona (ES)

(72) Inventors: Emilio López MATOS, Sant Cugat del Valles (ES); Roger Bastardas Puigoriol, Sant Just Desvern (ES); Santiago Garcia Garcia, Barcelona (ES)

(21) Appl. No.: 13/543,134

(22) Filed: Jul. 6, 2012

(51) Int. Cl. G06F 1/32

(52) U.S. Cl. 713/323

(57) ABSTRACT

A system having a low power operation mode and a normal operation mode, the system including a power supply unit for supplying at least a first voltage and a second voltage; a first circuit which operates during the normal operation mode but does not operate during the low power operation mode; a second circuit which operates during the low power operation mode; and a switching unit for selectively supplying the first circuit with the first voltage or the second voltage from the power supply unit; wherein the power supply unit supplies a power status signal and the switching unit is controlled based on the power status signal.

### BACKGROUND

The invention relates to a system having a lower power operation mode and a normal operation mode and to a method of controlling a power supply.

The invention can be used in peripheral devices, such as a printer, or in any other electronic system having a lower power mode of operation and a normal power mode of operation, such as a Stand-by mode and a Ready mode.

There are electronic systems, e.g. peripheral devices, which can switch between a low power mode of operation and a normal power mode of operation. The normal operation mode sometimes is called Ready mode where the device performs or is ready to perform its intended functions. The low power mode is sometimes called stand-by mode which is a power saving mode in which the load on the power supply is minimized. Such systems are designed to comply within energy saving regulations which might specify a maximum power consumption at the low power mode of operation, e.g. stand-by mode. Any circuit which is not necessary in the stand-by mode shall be powered-down but will again be supplied with power in the normal operation mode.

These type of power supplies, in which supply and power-down of circuits is controlled for minimizing power consumption in the stand-by mode, can be useful, for example, in printers, such as large format printers, office printers, etc. having an integrated power supply unit for powering internal electronics.

### SHORT DESCRIPTION OF DRAWINGS

FIG. 1 shows an example of a system comprising a power supply circuit and printer electronics;

FIG. 2 shows further details of the printer electronics of FIG. 1 according to an example.

### DETAILED DESCRIPTION

Examples of invention described herein provide a system having a low-power operation mode and a normal operation mode wherein the system is supplied from a power supply unit with at least a first voltage and a second voltage. The system comprises one or more first circuits which operate during the normal operation mode but do not operate during the low-power operation mode. Such circuits can, for example, be part of the printer electronics for controlling the operation of a printer, communication with a host device, and the like. When it is described that a circuit does not operate during the low-power operation mode, this also includes the case that a circuit goes to its lowest power consumption state so that the circuit can be powered-up at any time in a controller manner, as when a “wake-up” event occurs. The system further comprises at least one second circuit which operates during the low-power operation mode. The second circuit, for example, can be a stand-by circuit which operates during a stand-by mode to maintain minimum functions of a system, such as a peripheral device or printer, for example. One of these minimum functions could be a system wake-up function, for example. The first and second voltages provided by the power supply unit could be a normal operating voltage and a stand-by voltage, for example.

The system further comprises a switching unit for selectively supplying the first circuit with the first voltage or the second voltage from the power supply unit wherein the switching unit is controlled based on a power status signal supplied by the power supply unit. According to the status of the power supply unit, it hence is possible to selectively apply the first and second voltages to the first and second circuits or disconnect at least some of the circuits so as to minimize the power consumption, in particular during start-up of the power-supply, and still optimize and safeguard the operation of the system at all times from power-up to power-down.

In one example, the system is implemented in a peripheral device, such as a printer, wherein the second circuit comprises a stand-by circuit of device electronics; and the first circuit comprises another circuit of the device electronics. In the following description, instead of referring to first and second circuits, reference may be made to stand-by circuits and other circuits, wherein it should be understood that the invention is not limited to this example, nor to peripheral devices or printers. On the same token, instead of referring to first and second voltages, reference may be made to a stand-by voltage and a normal operating voltage, wherein it should be understood that the invention is not limited to these specific types of voltages.

In one example, the system is controlled in such a way that these stand-by circuits are always supplied with the stand-by voltage, whether the printer is in a normal operation mode, such as ready, or a low-power operation mode, such as stand-by, or transits between modes, e.g. from off to ready, from ready to stand-by, from stand-by to ready, from ready to off, or from stand-by to off. The other circuit of the device electronics can be disconnected during start-up of the system, can be supplied with the normal operating voltage during the normal operation mode, and can be supplied with the stand-by voltage during a transition from the normal operation mode to the stand-by mode. Connection and disconnection of the other circuits to and from power rails of the power supply unit can be controlled by the switching unit based on a power status signal provided by the power supply unit. The system allows to power only those circuits which are necessary at any particular operation mode, including transitions between modes, such as start-up and a transition from the normal operation mode to the low-power operation mode. The load on the power supply unit hence is reduced while, at all times, safeguarding proper operation of the overall system, including an orderly shut-down and transition to stand-by mode where it might be necessary to store information, reset states of logic and the like.

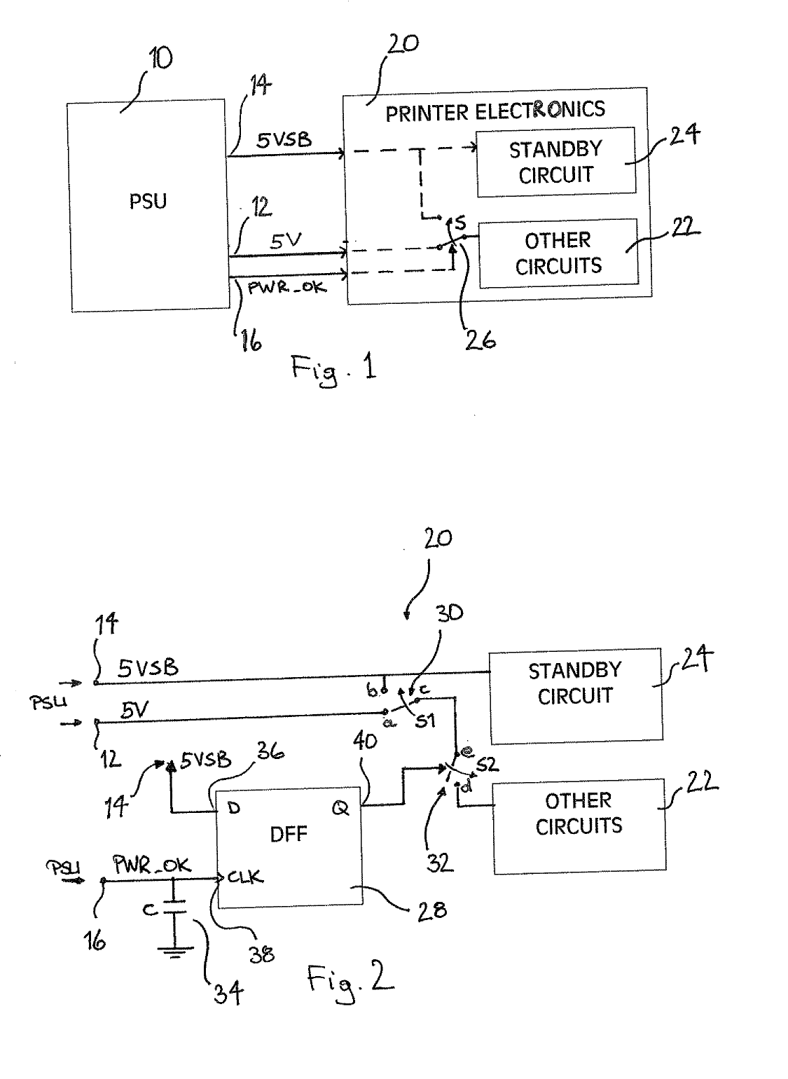

FIG. 1 schematically shows, in the form of a block diagram, one example of a system wherein, for the sake of clarity, many details of the system are omitted. In the example of FIG. 1, the system is a printer, such as a large format printer, office printer, home printer etc., without limiting the invention to this example. The printer system of FIG. 1 can operate in a low-power operation mode, also referred to as “stand-by”, and a normal operation mode, also referred to as “ready”. The printer system comprises a power supply unit 10 having a first output 12 for supplying a first voltage, a second output 14 for supplying a second voltage and a third output 16 for supplying a power status signal PWR_OK. The first voltage can be a normal operating voltage, such as 5V, and the second voltage can be a stand-by voltage, such as 5 VSB. The system further comprises printer electronics 20 including at least one first circuit 22 and one second circuit 24. The first circuit 22 operates during the normal operation mode but does not operate during the low-power operation mode and can be a circuit for controlling printing functions, communication functions of the printing system and the like. The second circuit 24 operates during the low-power operation mode and can be a stand-by circuit. A stand-by circuit can have the function of waking-up other circuits of the printer electronics upon detection of an external or internal event. Examples of external events are a user pressing a button, the insertion of print media into the printer system, a message which the printer system receives via a bus or other data connection terminal. An internal event can be a timing-out of a timer, for example. Printer electronics 20 further comprises a switching unit 26 for selectively connecting the other circuits 22 to the first output 12 or the second output 14 of the power supply unit 10.

The power supply unit 10 transforms the mains alternating current (AC) into a direct current (DC) to be used by the internal electronics 20 of the printer system or other device. In the example described, the direct current can be supplied at different rails or outputs 12, 14, which can have different or the same voltage levels. In order to limit the maximum power consumption of the system at any time, supply voltages from the two outputs or rails 12, 14 are supplied to the different circuits 22, 24 of the printer electronics 20 only as needed. Any circuits which are not necessary during particular operation modes, such as a stand-by mode, shall be powered-down and shall be supplied with the operating power from the first output only during the normal operation mode. However, when the printer systems needs to go from a normal operation mode to a low-power mode, circuits 22 necessary for controlling operation of the printer system often should not simply be disconnected from the power supply unit 10 as they might need some additional power to perform an orderly shut-down, e.g. for storing current status information, setting required states of logic or the like. On the other hand, if all of the circuits 22, 24 of the printer electronics were powered from the power supply unit 10 also during start-up of the printer system, malfunctioning of the system could occur because the power supply unit is not yet ready to provide the necessary power level. The present disclosure hence provides an easy and cheap circuit to switch DC voltage rails 12, 14 of the power supply unit 10 to the necessary circuits 22, 24 as needed, avoiding unnecessary power supply from the power supply unit 10 during cold start-up of the printer system but safeguarding necessary power supply during shut-down and transition to stand-by.

In the example described with reference to FIG. 1, the power supply unit provides the normal operation voltage at the first output 12 only once the power supply unit 10 has been fully powered-up whereas the second output 14 is able to supply the stand-by power voltage almost instantaneously after the power supply unit 10 is activated and begins to power-up. This almost instantaneous stand-by power voltage, however, is provided at a lower power level and hence would not be sufficient to fully power the printer system. The present system, during start-up of the printer system, hence avoids to supply power from the second output 14 (stand-by power voltage) to any circuits not involved in the low-power mode. On the other hand, during a transition from the normal operation mode to stand-by or off, the system allows to power, from the second output 14 (stand-by power voltage), also the other circuits 22 to ensure controlled shut-down. When the printer system, e.g. through its firmware, is sending a command to go to low-power mode, all other circuits 22 are going to the lowest power consumption state. This way they are consuming as little as possible from the second (5 VSB) power supply. At this low level, also the other circuits should be powered continuously, as when a “wake-up” event appears, they have to be able to wake-up in a controller manner.

For switching the power supply, switching unit 26 is controlled based on the power status signal PWR_OK supplied from the power supply unit 10. The PWR_OK signal can indicate that the power supply unit 10 has fully been powered-up by a transition from a LOW to a HIGH signal state or vice versa, for example. One example of controlling the switching unit 26 is as follows: When the power supply unit is in a start-up mode, the other circuits 22 are disconnected from the power supply unit 10 by the switching unit 10. Once the power supply unit is fully powered-up, as indicated by the power status signal PWR_OK, the printer system can go into a normal operation mode and the other circuits 22 can be connected to the first output 12 of the power supply unit 10, providing the normal operating power 5V. When the printer system transits from the normal operation mode to the low-power operation mode, the other circuits 22 are powered-down in a controlled manner and, for this purpose, are connected to the second output 14, providing the second voltage, such as 5 VSB. This can be accomplished by printer firmware, for example, preparing the printer electronics to transit to the stand-by mode. The stand-by circuit 24 stays connected to the second output 14 of the power supply unit 10 providing the second voltage 5 VSB, during all operation modes, including the normal operation mode, the low-power operation mode and the transition from the normal operation mode to the low-power operation mode.

In order to avoid that the power supply unit 10 needs to supply more power than available at any time, the printer system hence detects a start-up condition, using the power status signal PWR_OK, and avoids feeding the other circuits 22 from either one of the power rails 12, 14 during start-up of the system. When the start-up sequence has been completed, the switching unit 26 can connect the other circuits 22 to the normal operating power 5V at the first output rail 12.

FIG. 2 shows one example of the printer electronics 20 of the printer system of FIG. 1. In this example, the printer electronics 20 comprises, in addition to the other circuits 22 and the stand-by circuit 24, a D flip-flop 28 which can be a latch flip-flop activated by a rising edge, for example. The switching unit 26, in this example, comprises two analog switches 30, 32 or, alternatively, equivalent transistor circuits or other switching devices. Switches 30, 32 are also designated as S1 and S2. The printer electronics 20 is connected to the outputs 12, 14, 16 of the power supply unit 10, wherein reference is made to the description of FIG. 1. The flip-flop 28 comprises a D input 36 connected to the second output 14 of the power supply unit 10, a CLK input (clock input) 38 connected to the third output 16 of the power supply unit 10 via a capacitor C 34, and a Q output 40 connected to a control input of the second switch 32. The first switch 30 includes a common pole c, first pole a and second pole b, and the second switch comprises a first pole e and a second pole d. In this example, the first pole e of the second switch 32 is connected to a power supply input of the first circuit 22, and the second pole e of the second switch 32 is connected to the common pole c of the first switch 30. The first pole a of the first switch 30 is connected to the first output 12 of the power supply unit 10, and the second pole b of the first switch 30 is connected to the second output 14 of the power supply unit 10. The example of the printer electronics shown in FIG. 2 operates as follows:

The printer electronics 20 detects a start-up condition, such as cold start-up, based on the power status signal PWR_OK output from the power supply unit 10 at output 16. This signal is included in most power supply units according to the ATX standard and is actively HIGH (1). Of course, the invention is not limited to the use of this particular signal. If the power status signal PWR_OK is in a LOW state, such as 0V, this signals that the low-power voltage, such as 5 VSB, is the only output voltage present at the outputs 12, 14 of the power supply unit 10. After start-up has been completed, the remaining voltage rails, such as normal operating voltage 5V at the first output 12, are ready to use, and the power status signal PWR_OK goes to HIGH state, such as 5V or one (1). If any voltages other than the low-power voltage 5 VSB are switched off, the power status signal PWR_OK goes to the LOW state (0) again.

Accordingly, in the example shown in FIG. 2, the first time that the power supply unit is switched on, e.g. at printer start-up, the power status signal PWR_OK is LOW. The signal is connected through the capacitor C 34 to the raising edge clock input CLK 38 of the flip-flop 28. The capacitor C 34 inserts a delay in the rising edge of the power status signal PWR_OK and filters the signal from noise. At this time, the Q output 40 of the flip-flop 28 is at a LOW output value and the second switch S2 32 is open, as shown in FIG. 2. Further, the first switch S1 30 is in a default position a, as also shown in FIG. 2.

In the example shown, the D input 36 of the flip-flop 28 is always connected to the low-power operating voltage, 5 VSB, corresponding to a high voltage level. As soon as a rising edge of the power status signal PWR_OK is present at the CLK input 38, this high level is stored in the flip-flop 28 and transmitted to the Q output 40. This happens when the start-up of the power supply unit 10 is completed and when all rails 12, 14 of the power supply unit 10 are fully available to provide output power, as signaled by the rising edge of the power status signal PWR_OK.

When the Q output 40 of flip-flop 28 goes to a HIGH level (1), the second switch S2 32 is closed, i.e. connected to first pole d, while the first switch S1 30 remains in its default position, at the first pole a. Accordingly, the other circuits 22, i.e. circuits necessary for the normal operation of the printer system, are powered from the normal operating power rail 12 of the power supply unit 10.

When the printer system needs to switch to the low-power mode, printer firmware (not shown) prepares the printer system and drives the first switch S1, 30, to the second pole b so as to connect the other circuits 22 to the second output 14 of the power supply unit 10. At this time, the first or other circuits 22 are powered from the low-power voltage, 5 VSB, so that they are able to orderly go to the low-power mode. The first switch S1, 30, will remain in the second position b so that the other circuits 22 are always powered from 5 VSB during the low-power mode. When the firmware is sending the command to go to low-power mode, all these circuits 22 are going to the lowest power consumption state. This way they are consuming as little as possible from the 5 VSB power supply. But they will be powered all the time, as when a “wake-up” event appears, they have to be able to wake-up in a controller manner. Once the power supply unit 10 has been powered-down, the power status signal PWR_OK goes LOW but the Q output 40 of the flip-flop 28 remains in HIGH state (1) as no rising edge was present sent at CLK input, and no 0 was present at D input. Therefore, second switch S2 remains closed (d position) all the time, Accordingly, during all the low power mode state, the Q output 40 of flip-flop 28 is always HIGH (1) and the switch S2 is always closed, i.e. in d position.

During all times, the second circuit 24 remains connected to the second output 14 of the power supply unit 10. The second voltage or low operating voltage 5 VSB is always present during the normal operation mode, stand-by mode and shut-down, unless the power supply unit 10 is completely switched off turning a respective mechanical switch to the OFF or zero (0) position or unplugging the power cord from the inlet connected to mains. At this time, also the low operating power is off (0V) and the switch S2 shall be open. When the power supply unit 10 is switched on (at cold start-up), there will be a zero (0) at the Q output and the switch S2 hence will be open; only after there is at least low power (5 VSB) at the D input, the switch S2 will close (d position) at the first rising edge at the CLK input.

This disclosure presents a new simple and low-cost circuit to switch the voltage rails of the power supply unit to device circuits only when needed, in particular, avoiding supply power to circuits during the start-up process and hence avoiding malfunctioning of the whole system. On the other hand, when the system goes to a low power mode or is turned off, additional circuits can be provided with power from the stand-by voltage rail to ensure an orderly shut-down. The circuit disclosed detects the status of the power supply unit and controls the power supply to these additional circuits accordingly.

1. A system having a low power operation mode and a normal operation mode, the system including
a power supply unit for supplying at least a first voltage and a second voltage;
a first circuit which operates during the normal operation mode but does not operate during the low power operation mode;
a second circuit which operates during the low power operation mode; and
a switching unit for selectively supplying the first circuit with the first voltage or the second voltage from the power supply unit;
wherein the power supply unit supplies a power status signal and the switching unit is controlled based on the power status signal.

2. The system of claim 1 wherein the switching unit disconnects the power supply unit from the first circuit during start-up of the power supply unit.

3. The system of claim 2 wherein the switching unit supplies the first circuit with the first voltage during the normal operation mode and with the second voltage during the transition from the normal operation mode to the low power operation mode.

4. The system of claim 3, wherein the second circuit is supplied with the second voltage during the normal operation mode and during the transition from the normal operation mode to the low power operation mode.

5. The system of claim 4 wherein the system is implemented in a printer; the second circuit comprises a stand-by circuit of printer electronics; and the first circuit comprises another circuit of the printer electronics.

6. The system of claim 5 wherein the stand-by circuit comprises a circuit to wake-up the printer electronics when activated by a signal applied to the stand-by circuit.

7. A printer having a low power operation mode and a normal operation mode, the printer including:
a power supply unit having a first output for supplying a first voltage, a second output for supplying a second voltage, and a third output for supplying a power status signal;
a first circuit which operates during the normal operation mode but does not operate during the low power operation mode;
a second circuit which operates in the low power operation mode; and
a switching unit for connecting the first circuit to the first output or the second output of the power supply unit;
wherein the switching unit is connected to the third output providing the power status signal and is configured to disconnect the first circuit during start-up of the power supply unit, to connect the first circuit to the first output of the power supply unit during the normal operation mode, and to connect the first circuit to the second output of the power supply unit during a transition from the normal operation mode to the low power operation mode; and
wherein the second circuit is connected to the second output of the power supply unit during the normal operation mode, during the low power operation mode, and during the transition from the normal operation mode to the low power operation mode.

8. The printer of claim 7, wherein the switching unit is additionally controlled by printer firmware.

9. The printer of claim 7 wherein the switching unit comprises first and second switches, a flip-flop, and a capacitor,
the flip-flop having a D input connected to the second output of the power supply unit, a CLK input connected to the third output of the power supply unit via the capacitor and a Q output connected to a control input of the second switch;
the first switch having a common pole e, a first pole a and a second pole b, and the second switch having a first pole e and a second pole d, wherein the first pole of the second switch is connected to a power supply input of the first circuit and the second pole of the second switch is connected the common pole of the first switch, and wherein the first pole of the first switch is connected to the first output of the power supply unit and the second pole of the first switch is connected to the second output of the power supply unit.

10. A method of controlling power supply in a printer having a low power operation mode and a normal operation mode, the printer including a power supply unit, a first circuit and a second circuit, the method comprising the steps of:
during start-up of the printer, supplying a second voltage from the power supply unit to the second circuit and disconnecting the first circuit;
during the normal operation mode, supplying the second voltage from the power supply unit to the second circuit and supplying a first voltage from the power supply unit to the first circuit; and
during a transition from the normal operation mode to the low power operation mode, supplying the second voltage from the power supply unit to the first circuit and to the second circuit,
wherein the power supply unit outputs a status signal and supply of the first circuit with the first voltage is controlled in accordance with the status signal of the power supply unit.

11. The method of claim 10 wherein the first voltage is an operating voltage provided on a main supply rail of the power supply unit and the second voltage is a stand-by voltage provided on an auxiliary supply rail of the power supply unit.

12. The method of claim 10 wherein the first circuit is operating during the normal operation mode but does not operate during the low power operation mode.

13. The method of claim 12 wherein the first circuit is a circuit operating during the transition from the normal operation mode to the low power operation mode.

14. The method of claim 10 wherein the second circuit is operating during the low power operation mode.

15. The method of claim 10 wherein supply of the first circuit with the second voltage is controlled in accordance with a stand-by program provided in the printer for safely shutting-down the first circuit during the transition from the normal operation mode to the low power operation mode.

16. The method of claim 10 wherein the status signal indicates when the power supply unit has fully powered-up to supply both the first and second voltages and, when this is the case, the first circuit is connected the first voltage.

17. The method of claim 10 wherein the status of the power supply unit comprises at least start-up mode, normal operation mode, low power mode, and transition from normal operation mode to low power mode.
